(19) United States
(12) Patent Application Publication
(10) Pub. No.: US 2003/0171951 A1
(43) Pub. Date: Sep. 11, 2003

(54) Apparatus and method for automatically ordering medical goods in electronic commerce site

(75) Inventors: Hyun Jung Cho, Seoul (KR); Dong Il Lim, Seoul (KR)

Correspondence Address: Ladas & Parry, 26 61st Street, New York, NY, 10023, US

(73) Assignee: Institute of Information Technology Assesment

(21) Appl. No.: 10/094,777

(22) Filed: Mar. 11, 2002

(51) Int. Cl. G06F 17/60

(52) U.S. Cl. 705/2

(57) ABSTRACT

An apparatus and method for automatically ordering medical goods in an electronic commerce site. The automatic medical goods ordering apparatus and method can automatically order medical goods from a medical goods provider using an electronic commerce site in order to smoothly supply medical goods which consumers desire. Namely, in order to smoothly supply medical goods which consumers desire to purchase, the automatic medical goods ordering apparatus and method are capable of previously checking a purchase quantity of medical goods and automatically ordering necessary medical goods from a provider of the medical goods and holding expected optimum stocks of the medical goods. As a result, the present invention is highly efficient in that the consumers such as hospitals and pharmacies can easily purchase the medical goods, and, on the other hand, it is possible to minimize economic loss due to maintaining unnecessarily large stocks of the medical goods.

### BACKGROUND OF THE INVENTION

1. Field of the Invention

The present invention relates to an apparatus and method for automatically ordering medical goods in an electronic commerce site, and more particularly to an automatic medical goods ordering apparatus and method which can automatically order medical goods from a medical goods provider using an electronic commerce site in order to smoothly supply medical goods which consumers desire to purchase.

2. Description of the Related Art

Generally, consumers such as hospitals, pharmacies and the like which handle medical goods can purchase necessary medical goods by an offline telephone or facsimile, or through an electronic commerce site which sells the medical goods. The stocks of medical goods which a physical distribution center keeps to be sold through the electronic commerce site are not constant. Similarly, the amount of medical goods which the consumers want to purchase are also not constant. Accordingly, there is a difficulty in smoothly providing the medical goods according to consumers' desired purchase quantity of the medical goods.

If holding a large amount of the medical goods regardless of consumers' desired purchase quantity in order to overcome the above difficulty, the physical distribution center suffers high costs of physical distribution management and, as a result, cannot efficiently control the stocks of the medical goods.

### SUMMARY OF THE INVENTION

Therefore, the present invention has been made in view of the above problems, and it is an object of the present invention to provide an automatic medical goods ordering apparatus and method which can check a purchase quantity of medical goods, automatically order necessary medical goods from a provider of the medical goods and hold expected optimum stocks of the medical goods in order to smoothly supply medical goods when consumers desire to purchase.

In accordance with one aspect of the present invention, the above and other objects can be accomplished by the provision of an apparatus for automatically ordering medical goods in an electronic commerce site, the apparatus comprising provider communication means for inputting medical goods order information and outputting medical goods supply information about a medical goods supply according to the medical goods order information; physical distribution center communication means for inputting the medical goods supply information from the provider communication means, storing information about warehousing/purchase of the medical goods and outputting medical goods status data in response to a control signal; consumer communication means for outputting purchase information for a medical goods purchase through key operations of a consumer; and medical goods electronic commerce server for inputting the purchase information from the consumer communication means, selling medical goods on the basis of the purchase information, inputting the medical goods status data from the physical distribution center communication means, and outputting a control signal to output the medical goods order information on the basis of the inputted medical goods status data to the provider communication means.

In accordance with another aspect of the present invention, there is provided a method for automatically ordering medical goods in an electronic commerce site, the method comprising the steps of a) calculating expected optimum stocks of the medical goods according to a purchase quantity of medical goods which consumers have purchased through consumer communication means; b) inputting medical goods status data from physical distribution center communication means, calculating current stocks on the basis of the inputted medical goods status data, and determining whether the expected optimum stocks are less than or equal to the current stocks; c), if it is determined at the step b) that the expected optimum stocks exceed the current stocks, calculating an expected medical goods purchase quantity for a predetermined period of time; d) after calculating the expected medical goods purchase quantity, calculating safety stocks of the medical goods; and e) subtracting the current stocks from the expected optimum stocks, adding the safety stocks to the subtraction result to calculate an order quantity and outputting medical goods order information about the calculated order quantity to the provider communication means.

### BRIEF DESCRIPTION OF THE DRAWINGS

The above and other objects, features and other is advantages of the present invention will be more clearly understood from the following detailed description taken in conjunction with the accompanying drawings, in which:

FIG. 1 is a block diagram showing the construction of an apparatus for automatically ordering medical goods in an electronic commerce site in accordance with the present invention; and

FIG. 2 is a flow chart illustrating a procedure of automatically ordering medical goods in an electronic commerce site in accordance with the present invention.

### DESCRIPTION OF THE PREFERRED EMBODIMENTS

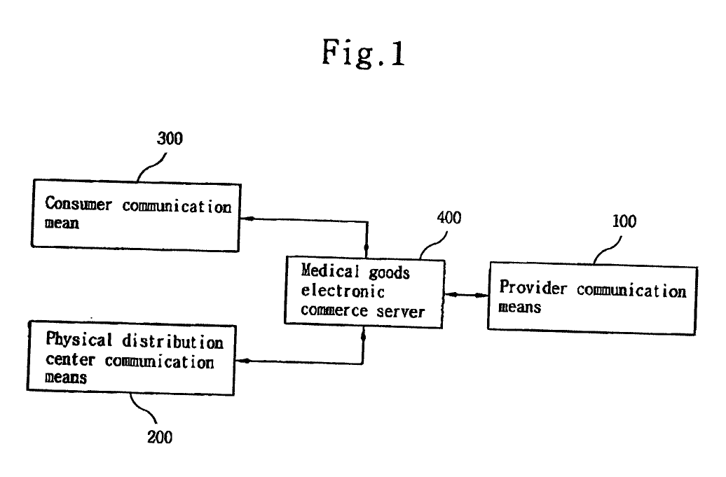

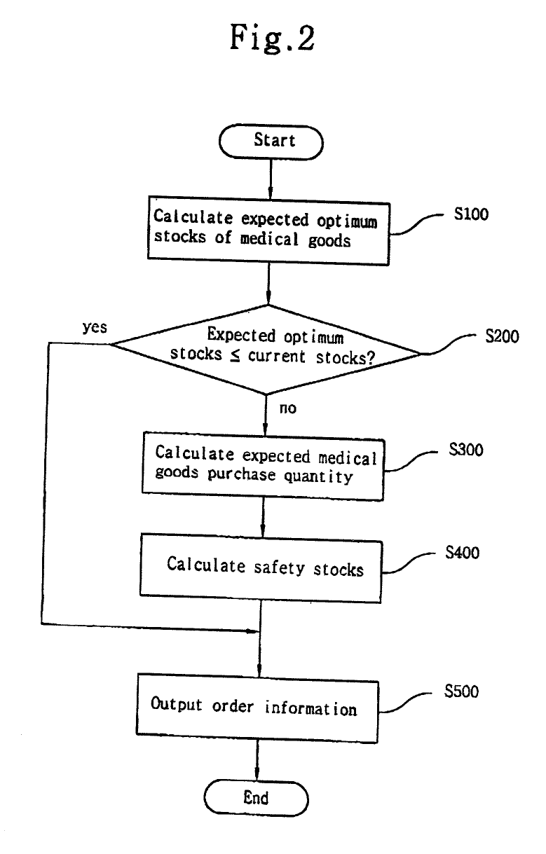

FIG. 1 is a block diagram showing the construction of an apparatus for automatically ordering medical goods in an electronic commerce site. FIG. 2 is a flow chart illustrating a procedure of automatically ordering the medical goods in the electronic commerce site.

As shown in FIG. 1, the automatic medical goods ordering apparatus of the present invention comprises provider communication means 100, physical distribution center communication means 200, consumer communication means 300 and medical goods electronic commerce server 400. The provider communication means 100 functions to input information about a medical goods order and output information about a medical goods supply.

The physical distribution center communication means 200 functions to input medical goods supply information outputted by the provider communication means 100 and store information about warehousing or purchase of medical goods. Further, the physical distribution center communication means 200 functions to input a control signal and output medical goods status data.

The consumer communication means 300 functions to output purchase information to purchase medical goods according to key operations by a consumer. The medical goods electronic commerce server 400 functions to input the purchase information from the consumer communication means 300 and sell corresponding medical goods to the consumer. Further, the medical goods electronic commerce server 400 functions to input the medical goods status data from the physical distribution center communication means 200, and output a control signal to the provider communication means to transfer medical goods order information according to the inputted medical goods status data.

Next, a description will be given of the operation of the automatic medical goods ordering apparatus using the electronic commerce site.

First, if a consumer such as a hospital, pharmacy or the like which handles medical goods performs key operations through its consumer communication means 300 in order to purchase necessary medical goods, the consumer communication means 300 outputs the purchase information for a medical goods purchase to the medical goods electronic commerce server 400. The communication means 300 may be, for example, a personal computer, notebook computer or workstation.

Upon inputting the purchase information from the consumer communication means 300, the medical goods electronic commerce server 400 sells medical goods desired by the consumer and then outputs the control signal corresponding to the medical goods sale to the physical distribution center communication means 200.

In response to the control signal from the medical goods electronic commerce server 400, the physical distribution center communication means 200 stores the medical goods warehousing/purchase information and outputs the medical goods status data to the medical goods electronic commerce server 400.

Then, the medical goods electronic commerce server 400 outputs the medical goods order information according to current stocks of medical goods on the basis of the medical goods status data from the physical distribution center communication means 400.

Upon inputting the medical goods order information from the medical goods electronic commerce server 400, the provider communication means 100 outputs the medical goods supply information corresponding to a medical goods supply to the medical goods electronic commerce server 400. An operator who operates the medical goods electronic commerce server 400 checks medical goods supplied offline on the basis of the medical goods supply information from the provider communication means 100. With these operations of the automatic medical goods ordering apparatus, it is possible to automatically order medical goods according to the current stocks of the medical goods.

Now, a detailed description will be given of the automatic medical goods ordering method with reference to FIG. 2. First, the medical goods electronic commerce server 400 calculates expected optimum stocks of medical goods according to a purchase quantity of medical goods which consumers have purchased through the consumer communication means 300 (S100).

Before calculating the expected optimum stocks of medical goods, the medical goods electronic commerce server 400 first inputs the medical goods status data from the physical distribution center communication means 200, and then calculates the expected optimum stocks on the basis of the medical goods status data. After this, the medical goods electronic commerce server 400 determines whether the calculated expected optimum stocks are less than or equal to the current stocks of medical goods (S200).

If it is determined at step 200 that the expected optimum stocks exceed the current stocks, then the medical goods electronic commerce server 400 calculates an expected medical goods purchase quantity for a predetermined period of time (S300).

After calculating the expected medical goods purchase quantity, the medical goods electronic commerce server 400 calculates safety stocks of medical goods (S400).

Then, the medical goods electronic commerce server 400 subtracts the current stocks from the expected optimum stocks and adds the safety stocks to the subtraction result to calculate an order quantity. The medical goods electronic commerce server 400 outputs medical goods order information about the calculated order quantity to the provider communication means 100 (S500).

On the other hand, if it is determined at step 200 that the calculated expected optimum stocks are less than or equal to the current stocks, the medical goods electronic commerce server 400 proceeds to step 500 to outputs medical goods order information to the provider communication means 100.

A description will be given of the above automatic order procedure on the basis of an example where there have been respectively sold specific goods of the number of 110, 105, 95, 105 and 95 a day over the past six days. In this case, a quantity of 100 ((110+105+95+90+105+95) /6) have been sold a day, on the average.

The operator of the medical goods electronic commerce site can freely set a period of time (in this case, six days) where the goods are sold to be a short time or a long time.

The safety stocks can be calculated on the basis of the average number of the goods. Before calculation of the safety stocks, there is need to first calculate a mean absolute deviation. Because the average number is 100, as calculated above, the mean absolute deviation is ((110−100)+(105−100)+(95−100)+(90−100)+(105−100)+(95−100))/6=6.67.

Then, a standard deviation is calculated. The standard deviation is 1.25×the mean absolute deviation, that is, 1.25×6.67=8.34.

The safety stocks can be calculated by the average number+@ where @ is a safety coefficient×the standard deviation. The safety coefficient can be determined to be 1.29, 1.65, 1.86, 2.06 or 2.33 according to a safety level. Assuming that the safety coefficient is determined to be 1.29, @ is 1.65×8.34=14.

Therefore, the safety stocks are 100 (the average number)+14=114. If the expected optimum stocks are 200 and the current stocks are 80, the order quantity of medical goods is the expected optimum stocks (200)−the current stocks (80)+safety stocks (114)=234. As a result, the order quantity of the goods is determined to be 234.

As apparent from the above description, the present invention provides an apparatus and method for automatically ordering medical goods in an electronic commerce site. The automatic medical goods ordering apparatus and method can automatically order medical goods from a medical goods provider using an electronic commerce site in order to smoothly supply medical goods which consumers desire to purchase. Namely, in order to smoothly supply medical goods which consumers desire to purchase, the automatic medical goods ordering apparatus and method is capable of checking a purchase quantity of medical goods and automatically ordering necessary medical goods from a provider of the medical goods and holding expected optimum stocks of the medical goods. As a result, the present invention is highly efficient in that the consumers such as hospitals and pharmacies can easily purchase the medical goods, and furthermore, it is possible to minimize economic loss due to maintaining unnecessarily large stocks of the medical goods.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for automatically ordering medical goods in an electronic commerce site, the apparatus comprising:
provider communication means for inputting medical goods order information and outputting medical goods supply information about a medical goods supply according to the medical goods order information;
physical distribution center communication means for inputting the medical goods supply information from the provider communication means, storing information about warehousing/purchase of the medical goods and outputting medical goods status data in response to a control signal;
consumer communication means for outputting purchase information for a medical goods purchase through key operations of a consumer; and
medical goods electronic commerce server for inputting the purchase information from the consumer communication means, selling medical goods on the basis of the purchase information, inputting the medical goods status data from the physical distribution center communication means, and outputting a control signal to output the medical goods order information on the basis of the inputted medical goods status data to the provider communication means.

2. A method for automatically ordering medical goods in an electronic commerce site, the method comprising the steps of:
a) calculating expected optimum stocks of the medical goods according to a purchase quantity of medical goods which consumers have purchased through consumer communication means;
b) inputting medical goods status data from physical distribution center communication means, calculating current stocks on the basis of the inputted medical goods status data, and determining whether the expected optimum stocks are less than or equal to the current stocks;
c), if it is determined at the step b) that the expected optimum stocks exceed the current stocks, calculating an expected medical goods purchase quantity for a predetermined period of time;
d) after calculating the expected medical goods purchase quantity, calculating safety stocks of the medical goods; and
e) subtracting the current stocks from the expected optimum stocks, adding the safety stocks to the subtraction result to calculate an order quantity and outputting medical goods order information about the calculated order quantity to the provider communication means.

3. The method as set forth in claim 2, further comprising the step of:
f), if it is determined at the step of a) that the expected optimum stocks are less than or equal to the current stocks, performing the step e).
